(19) United States
(12) Patent Application Publication
(10) Pub. No.: US 2019/0179901 A1
(43) Pub. Date: Jun. 13, 2019

(54) NON-TRANSITORY COMPUTER READABLE RECORDING MEDIUM, SPECIFYING METHOD, AND INFORMATION PROCESSING APPARATUS

(71) Applicant: FUJITSU LIMITED, Kawasaki-shi (JP)

(72) Inventors: Masahiro Kataoka, Kamakura (JP); Atsushi Shimano, Kawasaki (JP); Gyo Kubota, Kawasaki (JP)

(73) Assignee: FUJITSU LIMITED, Kawasaki-shi (JP)

(21) Appl. No.: 16/191,846

(22) Filed: Nov. 15, 2018

(30) Foreign Application Priority Data
Dec. 7, 2017 (JP) 2017-235511

(51) Int. Cl. G06F 17/27; G06F 17/30; G06F 17/16

(52) U.S. Cl. CPC G06F 17/2785; G06F 17/16; G06F 17/30598; G06F 17/2705

(57) ABSTRACT

The information processing apparatus generates, based on the accepted text, vectors including a plurality of dimensional values associated with a plurality of corresponding dimensions and specifies, from among the plurality of dimensions, a dimension in which the associated dimensional value meets the criterion. The information processing apparatus specifies, from among the plurality of dimensions, a dimension in which the associated dimensional value meets the criterion, compares the specified dimension with a storage unit that stores therein information that associates vectors each having a dimension in which the associated dimensional value meets the criterion with the positions of the corresponding vectors, regarding each of a plurality of texts, from among the dimensions included in the vectors of the texts; and specifies a text associated with the specified dimension from among the plurality of texts.

### CROSS-REFERENCE TO RELATED APPLICATION

This application is based upon and claims the benefit of priority of the prior Japanese Patent Application No. 2017-235511, filed on Dec. 7, 2017, the entire contents of which are incorporated herein by reference.

### FIELD

The embodiments discussed herein are related to a computer-readable recording medium or the like.

### BACKGROUND

There is a technology for responding to a question by searching, for an answer sentence when some question sentence is received, frequently asked questions (FAQ) that is associated with the received question. For example, in a conventional technology related to responding questions, a table in which a plurality of synonyms related to feature keywords is associated with candidates for an answer sentence (hereinafter, referred to as answer sentence candidates) is prepared. Then, in the conventional technology, when a question sentence is received, an answer sentence candidate is specified by performing morphological analysis on the question sentence, extracting the feature keywords, and comparing the synonyms associated with the extracted feature keywords with the table.

Here, in the conventional technology described above, by performing morphological analysis on the question sentence, the feature keywords are extracted and answer sentence candidates are narrowed down based on the synonyms of the extracted feature keywords; however, the accuracy may sometimes be unstable due to fluctuation of expressions of the synonyms or the like.

Furthermore, as another conventional technology, there is a technology for recommending content similar to a product that has been selected on an online shopping site. This technology previously calculates feature vectors of the content based on an introduction sentence of a product and creates an inverted index associated with the subject vectors. This technology increases the processing speed by acquiring the feature vectors of the product selected by a customer and searching for similar content based on the inverted index that is associated with the feature vectors.

Patent Document 1: Japanese Laid-open Patent Publication No. 2013-171550

Patent Document 2: Japanese Laid-open Patent Publication No. 2015-106346

### SUMMARY

According to an aspect of an embodiment, a non-transitory computer readable recording medium has stored therein a specifying program that causes a computer to execute a process including: generating, when accepting a text, based on the accepted text, vectors including a plurality of dimensional values associated with a plurality of corresponding dimensions; first specifying, from among the plurality of dimensions, a dimension in which the associated dimensional value meets the criterion; comparing the specified dimension with a storage unit that stores therein information that associates vectors each having a dimension in which the associated dimensional value meets the criterion with the positions of the corresponding vectors, regarding each of a plurality of texts, from among the dimensions included in the vectors of the texts; and second specifying a text associated with the specified dimension from among the plurality of texts.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a process performed by an information processing apparatus according to a first embodiment;

FIG. 2 is a functional block diagram illustrating a configuration of the information processing apparatus according to the first embodiment;

FIG. 3 is a diagram illustrating an example of a data structure of a question sentence DB according to the first embodiment;

FIG. 4 is a diagram illustrating an example of a process of generating text vector information;

FIG. 5 is a diagram illustrating an example of a process of specifying a positional relationship between dimensional components;

FIG. 6 is a flowchart illustrating the flow of a process performed by the information processing apparatus according to the first embodiment;

FIG. 7 is a diagram illustrating a process performed by an information processing apparatus according to a second embodiment;

FIG. 8 is a functional block diagram illustrating a configuration of the information processing apparatus according to the second embodiment;

FIG. 9 is a flowchart illustrating the flow of a process performed by the information processing apparatus according to the second embodiment; and

FIG. 10 is a diagram illustrating an example of a hardware configuration of a computer that implements the same function as that of the information processing apparatus.

### DESCRIPTION OF EMBODIMENTS

However, in the conventional technology described above, there is a problem in that it is not possible to specify the granularity of a plurality of chapters, sections, paragraphs constituting a text, such as a question sentence or an introduction sentence; the subject sentence (sentence); and the position thereof.

For example, as the conventional technology described above, because a question sentence is constituted by a plurality of sentences related to 5W1H, there is a need to calculate vectors in accordance with each sentence in order to perform maximum likelihood estimation of FAQs with high accuracy.

In contrast, in the conventional inverted index, because a question sentence or the like is identified by a pointer (or an ID number), the size thereof is large. Furthermore, because the dimensions of vectors are 100 to 1000, the size of the inverted index is synergistically increased. Thus, it is difficult to create an inverted index in accordance with a plurality of sentences. Furthermore, the dimension of vectors is also referred to as the polarity of vector.

Preferred embodiments of the present invention will be explained with reference to accompanying drawings. Furthermore, the present invention is not limited to the embodiments.

### [a] First Embodiment

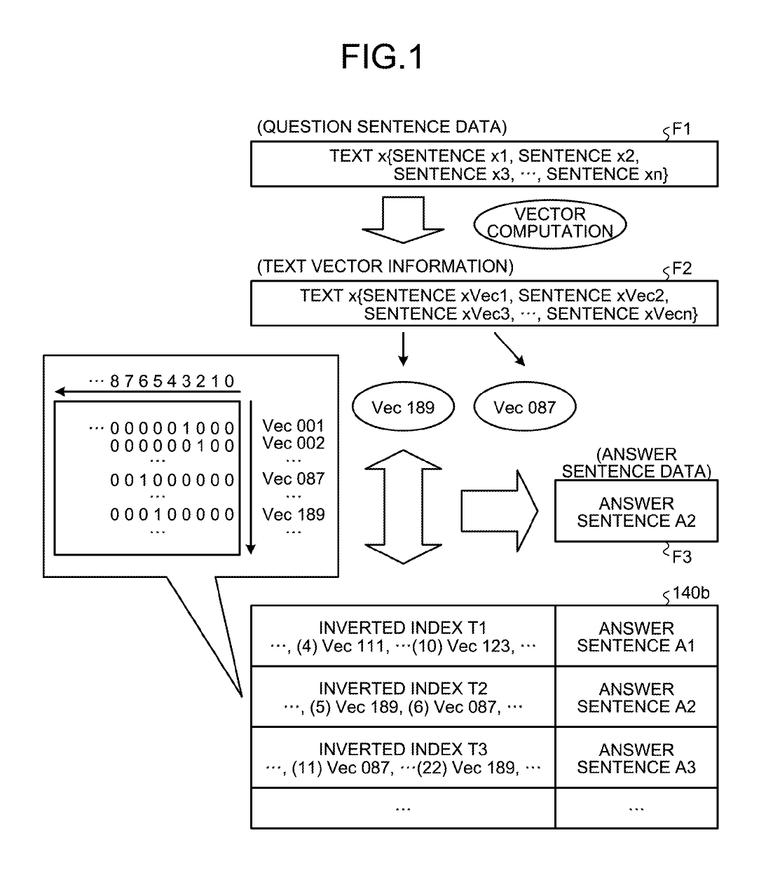

FIG. 1 is a diagram illustrating a process performed by an information processing apparatus according to a first embodiment. When the information processing apparatus according to the first embodiment acquires question sentence data F1, the information processing apparatus generates, based on the question sentence data F1 and a decision table 140b, answer sentence data F3 that is associated with the question sentence data F1.

In the question sentence data F1 according to the first embodiment, a single “text” is included. The text is formed of a plurality of “sentences”. Furthermore, the sentences are character strings that are separated by periods. For example, the text expressed by “A cluster environment is formed. All of shared resources have been vanished due to an operation error.” includes therein the sentences expressed by “A cluster environment is formed.” and “All of shared resources have been vanished due to an operation error.”.

In an explanation of FIG. 1, for convenience of description, a text x is included in the question sentence data F1. Furthermore, it is assumed that, a sentence x1, a sentence x2, a sentence x3, . . . , and a sentence xn are included in the text x.

The information processing apparatus generates text vector information F2 by calculating a vector of each of the sentences included in the text x. For example, in the text vector information F2, sentence vectors xVec1 to xVecn associated with a sentence x1 to a sentence xn, respectively, are included.

An example of a process in which the information processing apparatus calculates the sentence vector xVec1 of the sentence x1 will be described. The information processing apparatus calculates the sentence vector xVec1 by calculating, based on a Word2Vec technology, a word vector of each of the words included in the sentence x1 and accumulating each of the calculated word vectors. The information processing apparatus also similarly calculates sentence vectors xVec2 to xVecn regarding the other sentence x2 to sentence xn, respectively.

For example, a word vector is calculated based on a co-occurrence word that co-occurs before and after the word that is the calculation target of the word vector and is formed by a plurality of vector components associated with the co-occurrence words. For example, co-occurrence words of a word “apple” are highly likely to be “red”, “green”, “delicious”, and the like and, from among a plurality of vector components included in the word vectors of the word “apple”, the values associated with the components of “red”, “green”, and “delicious” tend to be increased.

The information processing apparatus specifies, from among each of the sentence vectors xVec1 to xVecn, sentence vectors in each of which the value of the vector component associated with a predetermined dimension is equal to or greater than a threshold. In a description below, a vector component associated with a predetermined dimension is appropriately referred to as a “dimensional component” and the value of the dimensional component is appropriately referred to as a “dimensional value”. Furthermore, the dimension of a vector is also called as the polarity of a vector.

In the first embodiment, as an example, it is assumed that the dimensional components are “Vec000 to Vec255”. For example, it is assumed that, from among each of the sentence vectors xVec1 to xVecn, the vectors in each of which the dimensional value is equal to or greater than the threshold are the sentence vector xVec2 and the sentence vector xVec3. It is assumed that, in the sentence vector xVec2, the dimensional value of the dimensional component “Vec189” is equal to or greater than the threshold. It is assumed that, in the sentence vector xVec3, the dimensional value of the dimensional component “Vec087” is equal to or greater than the threshold.

Consequently, in the text vector information F2 calculated from the question sentence F1, the dimensional components “Vec087” and “Vec189” are included and the positional relationship (order) of each of the dimensional components is in the order of “Vec189” and “Vec087”.

The information processing apparatus compares the decision table 140b with the type and the positional relationship of the dimensional components extracted from the text vector information F2 and specifies the answer sentence data F3 that is associated with the question sentence data F1.

The decision table 140b is a table in which inverted indices is associated with answer sentences. The inverted index indicates position information on a dimensional component. For example, an explanation will be given by using an inverted index T2. In the inverted index T2, offsets are indicated on the horizontal axis and the types of dimensional components are indicated on the vertical axis. The offset indicates position information on the position from the top and the top offset is set to “0”. If a subject dimensional component is present in the subject offset, a flag is set to “1” and, in the other cases, a flag is set to “0”.

The inverted index T2 indicates that a dimensional component “Vec001” is positioned at the offset “3” and a dimensional component “Vec002” is positioned at the offset “2”. Furthermore, the inverted index T2 indicates that the dimensional component “Vec189” is positioned at the offset “5” and the dimensional component “Vec087” is positioned at the offset “6”. Explanations of the relationship between the other dimensional components and the positions will be omitted.

For example, the information processing apparatus previously generates the decision table 140b by performing the process described below. The information processing apparatus learns the relationship between question sentence data and answer sentence data and generates text vector information from the subject question sentence data. Then, the information processing apparatus generates the decision table 140b by generating inverted indices based on the generated text vector information and by associating the generated inverted indices with the answer sentences.

Regarding also the inverted indices T1 and T3, similarly to the inverted index T2, the information processing apparatus also associates the offsets with the types of the vector components of the dimensions. Furthermore, the position of the flag in each of the inverted indices T1 and T3 is the position that is unique to each of the inverted indices T1 and T3. For example, in the example illustrated in FIG. 1, it is assumed that, in the inverted index T1, a dimensional component “Vec111” is positioned at the offset “4” and a dimensional component “Vec123” is positioned at the offset “10”. It is assumed that, in the inverted index T3, the dimensional component “Vec087” is positioned at the offset “11” and the dimensional component “Vec189” is positioned at the offset “22”.

In a description below, the inverted indices T1 to T3 and the other inverted indices included in the decision table 140b are collectively and appropriately referred to as an inverted index T.

Here, a description will be given of an example of a process in which the information processing apparatus compares the text vector information F2 with the decision table 140b and decides an answer sentence that is associated with the question sentence data F1. As described in FIG. 1, in the text vector information F2, the dimensional components “Vec189” and “Vec087” are included and the order thereof is “Vec189” and “Vec087”.

The information processing apparatus searches the inverted index T for an inverted index in which a flag “1” is to be set to the dimensional component included in the text vector information F2. For example, the inverted indices in which the flag “1” is to be set to the dimensional components “Vec189” and “Vec087” that are included in the text vector information F2 are the inverted index T2 and the inverted index T3.

Then, the information processing apparatus specifies an inverted index in which the dimensional components “Vec189” and “Vec087” included in the text vector information F2 are included and, also, the dimensional component “Vec087” is positioned after the dimensional component “Vec189”.

The inverted index T2 indicates that the dimensional component “Vec087” is positioned after the dimensional component “Vec189”. In contrast, the inverted index T3 indicates that the dimensional component “Vec189” is positioned after the dimensional component “Vec087”. Consequently, the information processing apparatus decides that the inverted index T associated with the types and the positional relationship of the dimensional components in the text vector information F2 is the inverted index T2. The information processing apparatus uses an answer sentence A2 associated with the inverted index T2 and creates the answer sentence data F3.

As described above, the information processing apparatus according to the first embodiment previously generates the decision table 140b in which each of the answer sentences is associated with the corresponding inverted index T in which the position information on the dimensional components is defined. When the information processing apparatus acquires the question sentence data F1, the information processing apparatus generates the text vector information F2 that is based on the question sentence data F1, compares the inverted index T with the type and the positional relationship of the dimensional components included in the generated text vector information F2, and specifies the inverted index that is associated with the type and the positional relationship of the dimensional component. The information processing apparatus uses the answer sentence associated with the specified inverted index and generates the answer sentence data F3. In this way, because the information processing apparatus specifies an answer sentence (text associated with the answer sentence) by comparing the inverted index T with the type and the positional relationship of the dimensional components included in the text vector information F2, it is possible to reduce the time needed to specify a text.

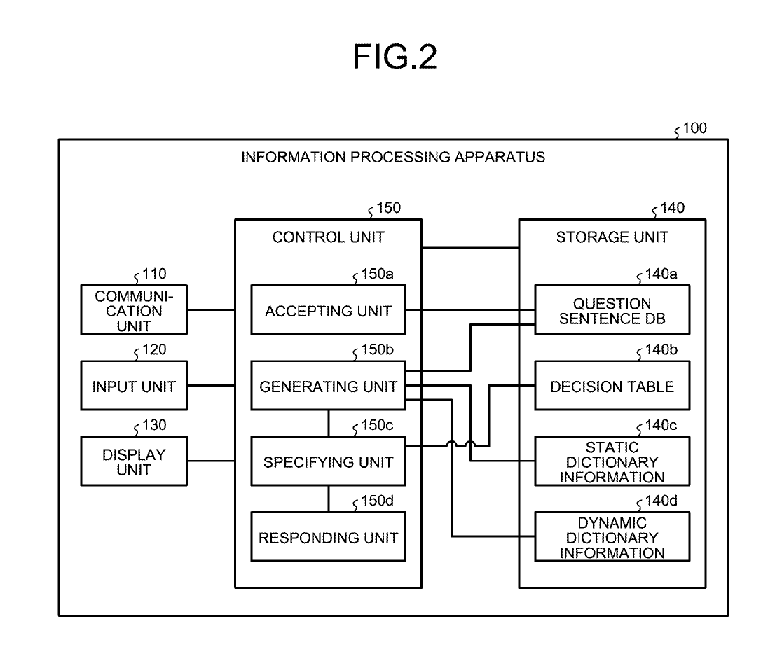

In the following, an example of a configuration of the information processing apparatus according to the first embodiment will be described. FIG. 2 is a functional block diagram illustrating the configuration of the information processing apparatus according to the first embodiment. As illustrated in FIG. 2, an information processing apparatus 100 includes a communication unit 110, an input unit 120, a display unit 130, a storage unit 140, and a control unit 150.

The communication unit 110 is a processing unit that performs data communication with another device via a network. For example, the communication unit 110 receives the question sentence data F1 from the other device and outputs the received question sentence data F1 to the control unit 150. Furthermore, the communication unit 110 sends the answer sentence data F3 output from the control unit 150 to the device that becomes the transmission source of the question sentence data F1. The communication unit 110 corresponds to a communication device. The control unit 150, which will be described later, sends and receives, via the communication unit 110, data to and from the other device by using the network.

The input unit 120 is an input device that inputs various kinds of information to the information processing apparatus 100. For example, the input unit 120 corresponds to a keyboard, a mouse, a touch panel, or the like. A user may operate the input unit 120 and input the question sentence data F1 to the information processing apparatus 100.

The display unit 130 is a display device that displays information output from the control unit 150. For example, the display unit 130 corresponds to a liquid crystal display, a touch panel, or the like. When the display unit 130 accepts the answer sentence data F3 from the control unit 150, the display unit 130 displays the accepted answer sentence data F3.

The storage unit 140 includes a question sentence database (DB) 140a, the decision table 140b, static dictionary information 140c, and dynamic dictionary information 140d. The storage unit 140 corresponds to a semiconductor memory device, such as a random access memory (RAM), a read only memory (ROM), or a flash memory, or a storage device, such as a hard disk drive (HDD).

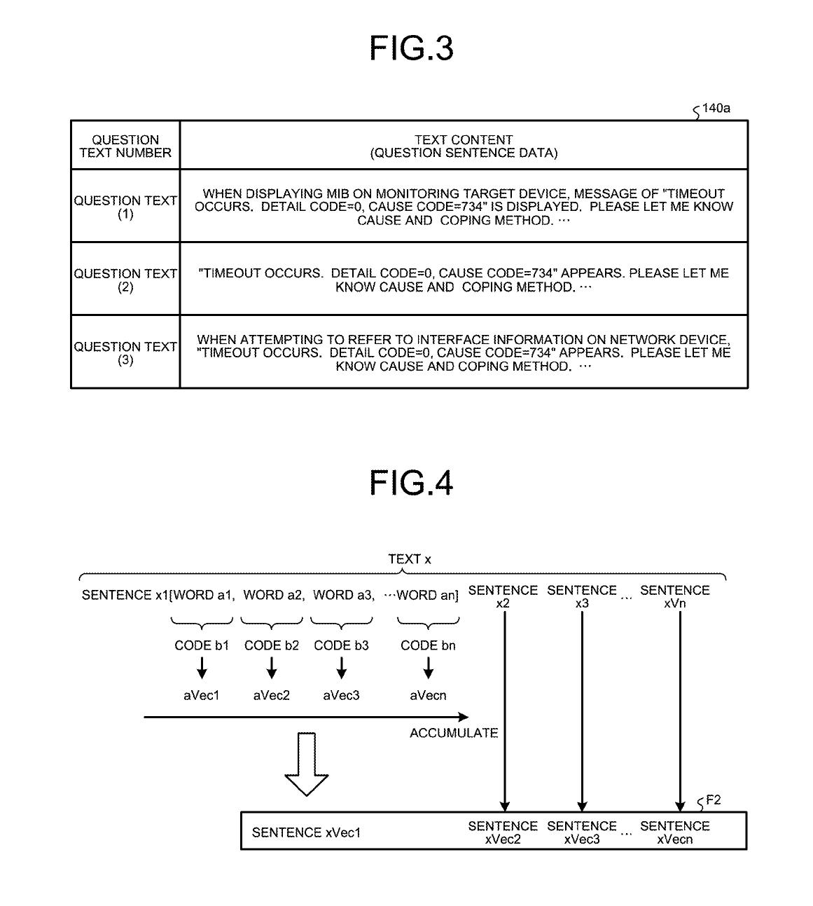

The question sentence DB 140a is a database that stores therein the question sentence data F1. FIG. 3 is a diagram illustrating an example of a data structure of the question sentence DB according to the first embodiment. As illustrated in FIG. 3, the question sentence DB 140a associates a question text number with text content (question sentence data). The question text number is information for uniquely identifying a group of a plurality of sentences that are included in a question text. The text content indicates the content of each of the texts associated with the corresponding question text numbers.

The decision table 140b is a table in which inverted indices are associated with corresponding answer sentences. The inverted index indicates position information on a dimensional component. As described in FIG. 1, in the inverted index, offsets are indicated on the horizontal axis, the types of the dimensional components are indicated on the vertical axis, and position information (offset) on a dimensional component is indicated by using the flag “1”. Other descriptions are the same as those described about the decision table 140b with reference to FIG. 2.

The static dictionary information 140c is information for associating a word with a static code.

The dynamic dictionary information 140d is information that is used to allocate a dynamic code to a word (or a character string) that has not been defined in the static dictionary information 140c.

The control unit 150 includes an accepting unit 150a, a generating unit 150b, a specifying unit 150c, and a responding unit 150d. The control unit 150 can be implemented by a central processing unit (CPU), a micro processing unit (MPU), or the like. Furthermore, the control unit 150 can also be implemented by hard-wired logic, such as an application specific integrated circuit (ASIC) or a field programmable gate array (FPGA).

The accepting unit 150a accepts the question sentence data F1 from the communication unit 110 or the input unit 120. The accepting unit 150a registers the accepted question sentence data F1 in the question sentence DB 140a. When the accepting unit 150a accepts the question sentence data F1 from the communication unit 110, the accepting unit 150a may also associate the question sentence data F1 with the information on the device that becomes the transmission source of the question sentence data F1 and register the information in the question sentence DB 140a.

The generating unit 150b is a processing unit that acquires the question sentence data F1 from the question sentence DB 140a and that generates the text vector information F2 based on the question sentence data F1. The generating unit 150b outputs the generated text vector information F2 to the specifying unit 150c.

In the following, an example of a process in which the generating unit 150b generates the text vector information F2 will be described. FIG. 4 is a diagram illustrating an example of the process of generating the text vector information. In FIG. 4, as an example, a process of generating the text vector information F2 on the text x will be described.

For example, in the text x, a sentence x1, a sentence x2, a sentence x3, . . . , and a sentence xn are included. The generating unit 150b calculates the sentence vector xVec1 of the sentence x1 as follows. The generating unit 150b encodes each of the words included in the sentence x1 by using the static dictionary information 140c and the dynamic dictionary information 140d.

For example, if a word hits in the static dictionary information 140c, the generating unit 150b performs encoding by specifying the static code of the word and replacing the word with the specified static code. If the word does not hit in the static dictionary information 140c, the generating unit 150b specifies a dynamic code by using the dynamic dictionary information 140d. For example, if a word has not been registered in the dynamic dictionary information 140d, the generating unit 150b registers the word in the dynamic dictionary information 140d and acquires the dynamic code associated with the registration position. If a word has already been registered in the dynamic dictionary information 140d, the generating unit 150b acquires the dynamic code associated with the registration position that has already been registered. The generating unit 150b performs encoding by replacing the word with the specified dynamic code.

In the example illustrated in FIG. 4, the generating unit 150b replaces a word a1 with a code b1, replaces a word a2 with a code b2, and replaces a word a3 with a code b3. Furthermore, the generating unit 150b performs encoding by replacing a word an with a code bn.

After having performed encoding on each of the words, the generating unit 150b calculates, based on the Word2Vec technology, a word vector of each of the words (codes). The Word2Vec technology is used to perform a process of calculating a vector of each code based on the relationship between a certain word (code) and another adjacent word (code). In the example illustrated in FIG. 4, the generating unit 150b calculates word vectors aVec1 to aVecn of the code b1 to the code bn, respectively. The generating unit 150b calculates the sentence vector xVec1 of the sentence x1 by accumulating each of the word vectors aVec1 to aVecn. The generating unit 150b may also perform averaging by dividing the accumulated vector by the number of words (codes) included in the sentence x and may also set the averaged vector to the sentence vector xVec1.

As described above, the generating unit 150b calculates the sentence vector xVec1 of the sentence x1. The specifying unit 150c also calculates the sentence vectors xVec2 to xVecn by performing the same process on the sentence x2 to the sentence nx. In this way, the generating unit 150b generates the text vector information F2 and outputs the generated text vector information F2 to the specifying unit 150c.

Here, a description has been given of an example in which the generating unit 150b generates the text vector information F2 by using the granularity of each of the sentences included in the text; however, the generating unit 150b may also generate the text vector information F2 by using another granularity. For example, the generating unit 150b may also generate the text vector information F2 by using one of the chapters, sections, and paragraphs of a text as the granularity. If chapters are used as the granularity, the generating unit 150b calculates a chapter vector by accumulating the word vectors included in the chapter. By also performing the same processes on the other chapters, the generating unit 150b calculates each of the chapter vectors. When sections and paragraphs of the text are used as the granularity, the generating unit 150b similarly calculates a section vector and a paragraph vector.

The specifying unit 150c is a processing unit that specifies an answer sentence associated with the question sentence data F1 based on the text vector information F2 and the decision table 140b. First, the specifying unit 150c specifies the type and the positional relationship of the dimensional components included in the text vector information F2.

The specifying unit 150c previously holds the information on each of the types of vector components of dimensions. In the first embodiment, as an example, it is assumed that the types of the dimensional components are “Vec000 to Vec255”. The specifying unit 150c compares a dimensional value of a dimensional component with a threshold from among the vector components included in the sentence vector xVec1 included in the text vector information F2 and decides whether the dimensional component in which the dimensional value of the dimensional component is equal to or greater than the threshold is included. The specifying unit 150c also repeatedly performs the same process on the sentence vectors xVec2 to xVecn included in the text vector information F2.

The specifying unit 150c specifies the sentence vector that has a dimensional component in which the dimensional value is equal to or greater than the threshold and specifies the type of a dimensional component in which the dimensional value included in the subject sentence vector is equal to or greater than the threshold. Furthermore, the specifying unit 150c specifies a positional relationship of the sentence vector that has a dimensional component in which the dimensional value is equal to or greater than the threshold. Here, specifying the positional relationship of the sentence vectors each having the dimensional component in which the dimensional value is equal to or greater than the threshold corresponds to specifying the type of the dimensional components included in the text vector information F2 and the positional relationship of each of the dimensional component.

For example, in the example illustrated in FIG. 1, from among the sentence vectors xVec1 to xVecn, the vectors each having a dimensional component in which a dimensional value is equal to or greater than the threshold are the sentence vector xVec2 and the sentence xVec3. Furthermore, regarding the sentence vector xVec2, the dimensional value of the dimensional component “Vec189” is equal to or greater than the predetermined dimensional value and, regarding the sentence vector xVec3, the dimensional value of the dimensional component “Vec087” is equal to or greater than the predetermined dimensional value. The types and the positional relationships of the dimensional components in each of which the dimensional value is equal to or greater than the threshold are the “Vec189” and the “Vec087” in this order.

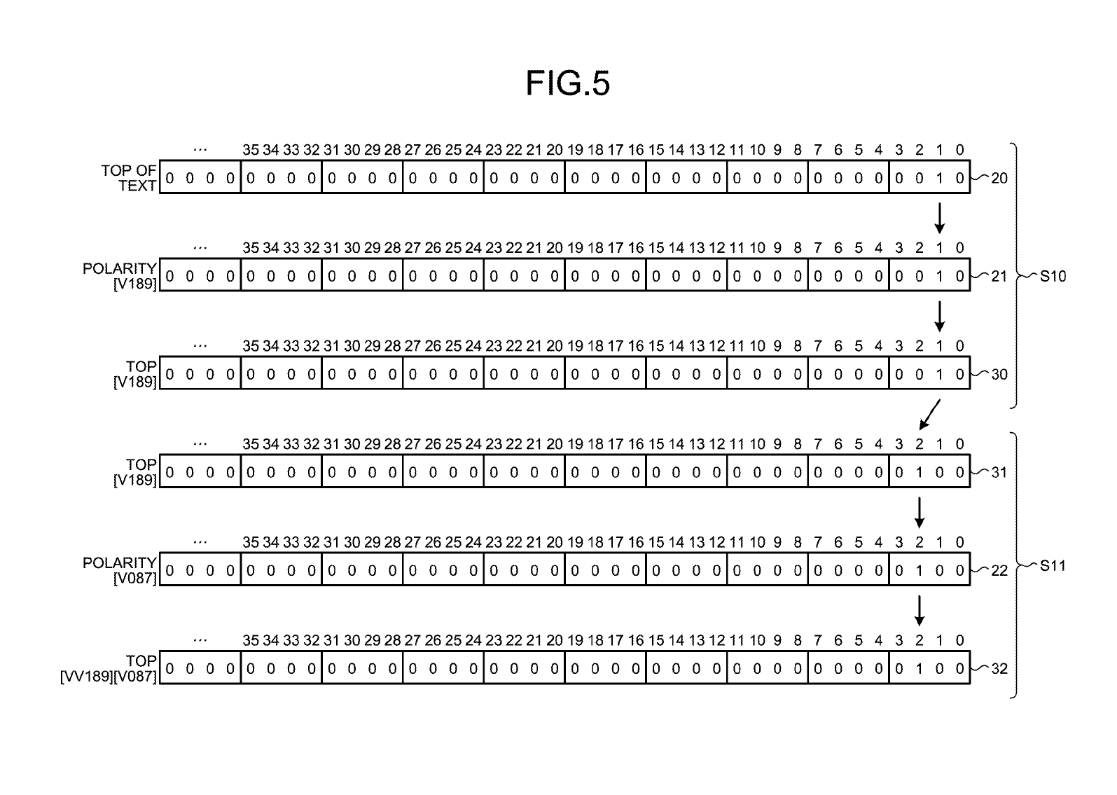

In the following, a description will be given of an example in which the specifying unit 150c specifies the positional relationship of the dimensional components included in the text vector information F2. FIG. 5 is a diagram illustrating an example of the process of specifying a positional relationship of dimensional components. In FIG. 5, as an example, a description will be given of a case of specifying the positional relationship of the dimensional components “Vec087” and “Vec189”.

The specifying unit 150c scans the text vector information F2 and generates bitmaps 20, 21, and 22. The horizontal axis of each of the bitmaps indicates the offsets and the top offset is set to “0”. In each of the bitmaps, the flag “1” is set to the offset related to the subject information.

The bitmap 20 indicates the top position of the sentence vector that has the dimensional component in which the dimensional value is equal to or greater than the threshold. As described in FIG. 1, in the text vector information F2, the top of the sentence vector that has the dimensional component in which the dimensional value is equal to or greater than the threshold is the second sentence vector xVec2. Consequently, the specifying unit 150c sets the flag “1” to the offset “1” in the bitmap 20.

The bitmap 21 indicates the position of the sentence vector in which the dimensional value of the dimensional component “Vec189” is equal to or greater than the threshold. As described in FIG. 1, in the text vector information F2, the sentence vector in which the dimensional value of the dimensional component “Vec189” is equal to or greater than the threshold is the second sentence vector xVec2. Consequently, the specifying unit 150c sets the flag “1” to the offset “1” in the bitmap 21.

The bitmap 22 indicates the position of the sentence vector in which the dimensional value of the dimensional component “Vec087” is equal to or greater than the threshold. As described in FIG. 1, in the text vector information F2, the sentence vector in which the dimensional value of the dimensional component “Vec087” is equal to or greater than the threshold is the third sentence vector xVec3. Consequently, the specifying unit 150c sets the flag “1” to the offset “2” in the bitmap 21.

A process performed at Step S10 will be described. The specifying unit 150c acquires a bitmap 30 by performing the AND operation on the bitmap 20 and the bitmap 21. In the bitmap 30, because the flag “1” is set to the offset “1”, the specifying unit 150c specifies that the dimensional component “Vec189” is positioned at the top.

A process performed at Step S11 will be described. The specifying unit 150c performs left shifting on the bitmap 30 and generates a bitmap 31. The specifying unit 150c acquires a bitmap 32 by performing the AND operation on the bitmap 31 and the bitmap 22. In the bitmap 32, because the flag “1” is set to the offset “2”, the specifying unit 150c specifies that the dimensional component “Vec087” is positioned at the position subsequent to the top.

By performing the process illustrated in FIG. 5, the specifying unit 150c specifies the type and the positional relationship of the dimensional components included in the text vector information F2. Furthermore, the specifying unit 150c may also perform another process and specify the type and the positional relationship of the dimensional components included in the text vector information F2.

After having specified the type and the positional relationship of the dimensional components, the specifying unit 150c compares the type and the positional relationship of the specified dimensional components with the inverted index T stored in the decision table 140b and specifies the answer sentence associated with the question sentence data F1.

The specifying unit 150c searches the inverted index T for the inverted index in which the flag “1” is to be set to the type of the dimensional component that has the dimensional value equal to or greater than the threshold. For example, if it is assumed that the dimensional components each having the dimensional value that is equal to or greater than the threshold specified from the text vector information F2 are “Vec189” and “Vec087”, the specifying unit 150c specifies the inverted index T2 and the inverted index T3 illustrated in FIG. 1.

If the specifying unit 150c specifies a plurality of inverted indices, the specifying unit 150c narrows down the inverted indices by using, as a key, the type and the positional relationship of the dimensional components that are specified from the text vector information F2. For example, because the dimensional component “Vec087” appearing after the dimensional component “Vec189” is stored in the inverted index T2, the specifying unit 150c ultimately specifies the inverted index T2. The specifying unit 150c acquires the answer sentence A2 associated with the inverted index T2 from the decision table 140b and outputs the answer sentence A2 to the responding unit 150d.

Furthermore, the specifying unit 150c may also search the inverted index T for the inverted index in which the flag “1” is to be set to the type of the dimensional components in each of which the dimensional value is equal to or greater than the threshold and specify, in a case where only a single inverted index is present, the single inverted index regardless of the positional relationship. The specifying unit 150c acquires the answer sentence associated with the specified inverted index from the decision table 140b and outputs the answer sentence to the responding unit 150d.

The responding unit 150d is a processing unit that generates the answer sentence data F3 based on the answer sentence to be acquired from the specifying unit 150c and that sends the generated answer sentence data F3 to the device that becomes the transmission source of the question sentence data F1. If the responding unit 150d has accepted the question sentence data F1 from the input unit 120, the responding unit 150d outputs the answer sentence data F3 to the display unit 130 and allows the display unit 130 to display the answer sentence data F3.

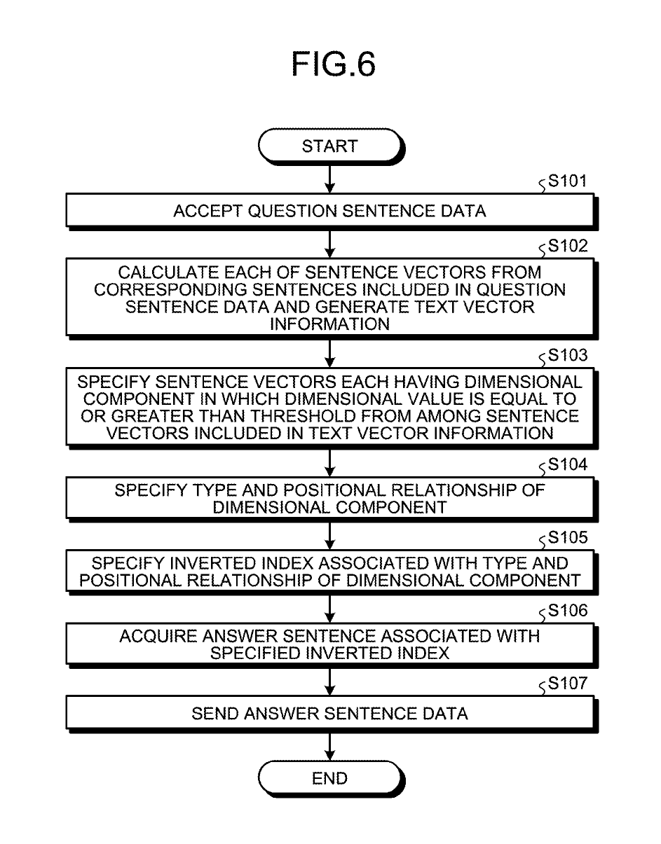

In the following, an example of the flow of a process performed by the information processing apparatus 100 according to the first embodiment will be described. FIG. 6 is a flowchart illustrating the flow of the process performed by the information processing apparatus according to the first embodiment. As illustrated in FIG. 6, the accepting unit 150a according to the information processing apparatus 100 acquires the question sentence data F1 (Step S101).

The generating unit 150b in the information processing apparatus 100 calculates each of the sentence vectors from the corresponding sentences included in the question sentence data F1 and generates the text vector information F2 (Step S102). The specifying unit 150c in the information processing apparatus 100 specifies the sentence vectors each having the dimensional component in which the dimensional value is equal to or greater than the threshold from among the sentence vectors included in the text vector information F2 (Step S103).

The specifying unit 150c specifies the type and the positional relationship (order) of the dimensional components based on the text vector information F2 (Step S104). The specifying unit 150c specifies the inverted index associated with the type and the positional relationship of the dimensional components (Step S105). The specifying unit 150c acquires the answer sentence associated with the specified inverted index (Step S106). The responding unit 150d transmits the answer sentence data F3 to the device that is the transmission source of the question sentence data F1 (Step S107).

In the following, the effects of the information processing apparatus 100 according to the first embodiment will be described. The information processing apparatus 100 previously generates the decision table 140b in which answer sentences are associated with the inverted index T in which position information on the dimensional component is defined. When the information processing apparatus 100 acquires the question sentence data F1, the information processing apparatus 100 generates the text vector information F2 based on the question sentence data F1, compares the inverted index T with the type and the positional relationship of the dimensional components included in the generated text vector information F2, and specifies the inverted index associated with the type and the positional relationship of the dimensional components. The information processing apparatus 100 uses answer sentence associated with the specified inverted index and generates the answer sentence data F3. In this way, because the answer sentence (text associated with the answer sentence) is specified by comparing the inverted index T with the type and the positional relationship of the dimensional components included in the text vector information F2, it is possible to specify a plurality of sentences that constitute a text and the position of the sentences with high accuracy.

### [b] Second Embodiment

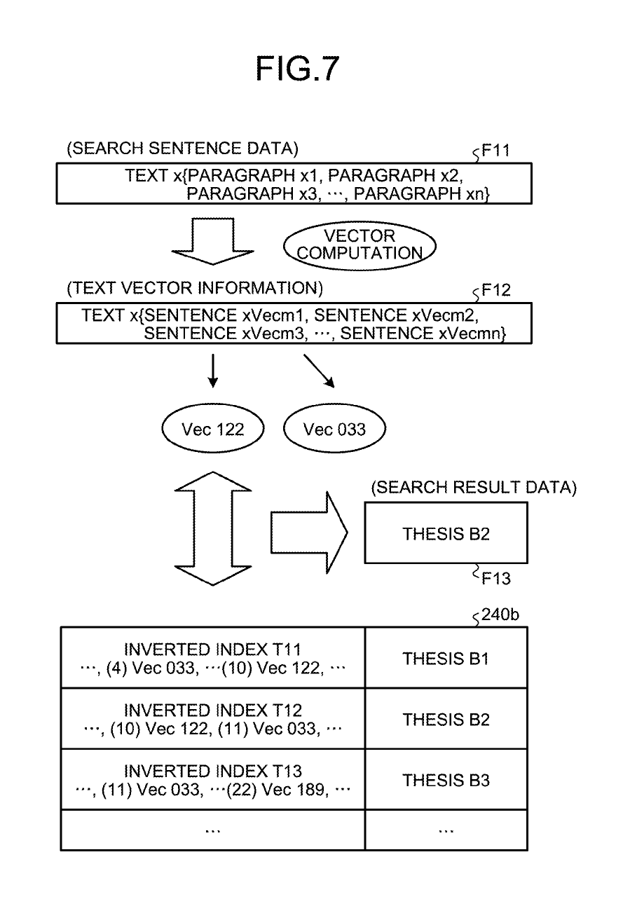

FIG. 7 is a diagram illustrating a process performed by an information processing apparatus according to a second embodiment. When the information processing apparatus according to the second embodiment acquires search sentence data F11 in which a search condition is described, the information processing apparatus generates search result data F13 that is associated with search data F11 based on the search sentence data F11 and a decision table 240b.

In the search sentence data F11 according to the second embodiment, a single “text” is included. The text is formed of a plurality of “sentences”. Furthermore, the sentences are character strings that are separated by periods. A description related to a text is the same as that described about the question sentence data F1 in the first embodiment.

In an explanation of FIG. 7, for convenience of description, the text x is included in the search sentence data F11. Furthermore, it is assumed that the paragraph x1, the paragraph x2, the paragraph x3, . . . , and the paragraph xn are included in the text x. Furthermore, it is assumed that a sentence x11, a sentence x12, a sentence x13, . . . , and a sentence x1n (not illustrated) are included in the paragraph x1. It is assumed that a sentence xm1, a sentence xm2, . . . , and a sentence xmn (not illustrated) are included in a paragraph xm.

The information processing apparatus generates the text vector information F12 by calculating a vector of each of the sentences included in the text x. For example, in the text vector information F12, the sentence vectors xVecm1 to xVecmn associated with the sentence xm1 to the sentence xmn, respectively, in the paragraph xm are included.

A description will be given of an example of a process in which the information processing apparatus calculates the sentence vector xVecm1 of the sentence xm1 in the paragraph xm. The information processing apparatus calculates the sentence vector xVecm1 by calculating, based on the Word2Vec technology, a word vector of each of the words included in the sentence xm1 and accumulating each of the calculated word vectors. The information processing apparatus similarly calculates sentence vectors xVecm2 to xVecmn regarding the other sentence xm2 to the sentence xmn, respectively.

The information processing apparatus specifies, from among the sentence vectors xVecm1 to xVecmn, sentence vectors in each of which the dimensional value of the predetermined dimensional component is equal to or greater than the threshold.

In the second embodiment, similarly to the first embodiment, it is assumed that the dimensional components are “Vec000 to Vec255”. For example, it is assumed that, from among each of the sentence vectors xVecm1 to xVecmn, the vectors in each of which the dimensional value is equal to or greater than the threshold are the sentence vector xVecm2 and the sentence vector xVecm3. In the sentence vector xVecm1, it is assumed that the dimensional value of the dimensional component “Vec122” is equal to or greater than the threshold. In the sentence vector xVecm2, it is assumed that the dimensional value of the dimensional component “Vec033” is equal to or greater than the threshold.

Consequently, in the text vector information F12 calculated from the search sentence data F11, the dimensional components “Vec033” and “Vec122” are included and the order (positional relationship) of each of the dimensional components is “Vec122” and “Vec033”.

The information processing apparatus compares the type and the positional relationship of the dimensional components extracted from the text vector information F12 with the decision table 240b and specifies the search result data F13 that is associated with the search sentence data F11.

The decision table 240b is a table in which the inverted indices are associated with the answer sentences. The inverted index indicates the position information on a dimensional component. The inverted index is information that indicates the relationship between the offset and the type of the dimensional component by using the flag “1”. The other descriptions of the inverted index are the same as those of the inverted index described in the first embodiment with reference to FIG. 1.

Furthermore, in an inverted index T11, it is indicated that the dimensional component “Vec033” is positioned at the offset “4” and the dimensional component “Vec122” is positioned at the offset “10”. In an inverted index T12, it is indicated that the dimensional component “Vec122” is positioned at the offset “10” and the dimensional component “Vec033” is positioned at the offset “11”. In an inverted index T13, it is indicated that the dimensional component “Vec033” is positioned at the offset “11” and the dimensional component “Vec189” is positioned at the offset “22”. Explanations of the relationship between the other dimensional components and the positions will be omitted. In a description below, the inverted indices T11 to T13 and the other inverted indices included in the decision table 240b are collectively and appropriately referred to as the inverted index T.

For example, the information processing apparatus performs the following process and previously generates the decision table 240b. The information processing apparatus collects thesis data and generates text vector information from the thesis data. Then, the information processing apparatus generates the decision table 240b by generating inverted indices based on the generated text vector information and associating the generated inverted indices with the thesis data that corresponds to the generation source of the inverted indices.

In the following, a description will be given of an example of a process in which the information processing apparatus compares the text vector information F12 with the decision table 240b and decides the search result data F13 that is associated with the search sentence data F11. As described in FIG. 7, in the text vector information F12, the dimensional components “Vec122” and “Vec033” are included and the positional relationship is in the order of “Vec122” and “Vec033”.

The information processing apparatus searches the inverted index T for the inverted index in which the flag “1” is to be set to each of the dimensional components in the text vector information F12. For example, the inverted indices in which the flag “1” is set to the dimensional components “Vec122” and “Vec033” included in the text vector information F12 are the inverted index T11 and the inverted index T12.

Then, the information processing apparatus specifies the inverted indices in which the dimensional components “Vec122” and “Vec033” included in the text vector information F12 are included and, also, the dimensional component “Vec033” is positioned after the dimensional component “Vec122”.

The inverted index T11 indicates that the dimensional component “Vec122” is positioned after the dimensional component “Vec033”. In contrast, the inverted index T12 indicates that the dimensional component “Vec033” is positioned after the dimensional component “Vec122”. Consequently, the information processing apparatus decides that the inverted index T associated with the type and the positional relationship of the dimensional components in the text vector information F12 is the inverted index T12. The information processing apparatus generates the search result data F13 by using a thesis B2 that is associated with the inverted index T12.

As described above, the information processing apparatus according to the second embodiment previously generates the decision table 240b in which theses are associated with the inverted indices T in which the position information on the dimensional component is defined. When the information processing apparatus acquires the search sentence data F11, the information processing apparatus generates the text vector information F12 that is based on the search sentence data F11, compares the inverted index T with the type and the positional relationship of the dimensional components included in the generated text vector information F12, and specifies the inverted indices associated with the type and the positional relationship of the dimensional component. The information processing apparatus uses the thesis associated with the specified inverted index and generates the search result data F13. In this way, because the information processing apparatus specifies a thesis (text associated with the thesis) by comparing the inverted index T with the type and the positional relationship of the dimensional components included in the text vector information F12, it is possible to reduce the time needed to specify a text.

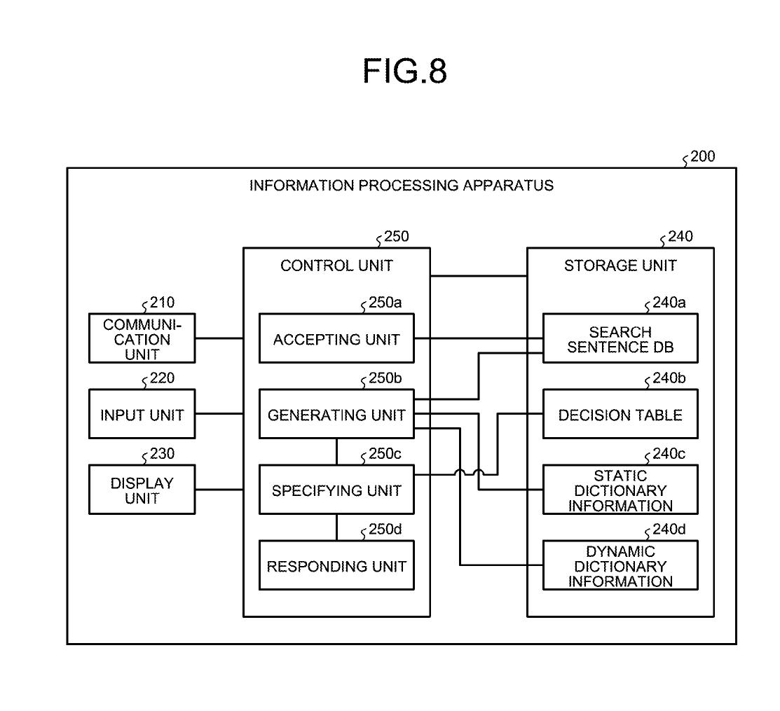

In the following, a description will be given of a configuration of the information processing apparatus according to the second embodiment. FIG. 8 is a functional block diagram illustrating the configuration of the information processing apparatus according to the second embodiment. As illustrated in FIG. 8, an information processing apparatus 200 includes a communication unit 210, an input unit 220, a display unit 230, a storage unit 240, and a control unit 250.

The communication unit 210 is a processing unit that performs data communication with another device via a network. For example, the communication unit 210 receives the search sentence data F11 from the other device and outputs the received search sentence data F11 to the control unit 250. Furthermore, the communication unit 210 sends the search result data F13 output from the control unit 250 to the device that becomes the transmission source of the search sentence data F1. The communication unit 210 corresponds to a communication device. The control unit 250, which will be described later, sends and receives data to and from the other device via the communication unit 210 by using the network.

The input unit 220 is an input device that inputs various kinds of information to the information processing apparatus 200. For example, the input unit 220 corresponds to a keyboard, a mouse, a touch panel, or the like. A user may also operate the input unit 120 and input the search sentence data F11 to the information processing apparatus 200.

The display unit 230 is a display device that displays information output from the control unit 250. For example, the display unit 230 corresponds to a liquid crystal display, a touch panel, or the like. When the display unit 230 accepts the search result data F13 from the control unit 150, the display unit 230 displays the received search result data F13.

The storage unit 240 includes a search sentence DB 240a, the decision table 240b, a static dictionary information 240c, and a dynamic dictionary information 240d. The storage unit 240 corresponds to a semiconductor memory device, such as a RAM, a ROM, or a flash memory, or a storage device, such as an HDD.

The search sentence DB 240a is a database that stores therein the search sentence data F11. For example, the search sentence DB 240a associates a search sentence chapter number with text content (search sentence data). The search sentence chapter number is information for uniquely identifying a group of a plurality of sentences included in a search sentence chapter. The text content indicates the content of each of the texts that are associated with the corresponding search sentence chapter numbers.

The decision table 240b is a table in which inverted indices are associated with theses. Each of the inverted indices indicates the position information on a dimensional component. As described in FIG. 7, in the inverted index, the offsets are indicated on the horizontal axis, the types of dimensional components are indicated on the vertical axis, and the position information (offset) on a dimensional component is indicated by using the flag “1”. The other descriptions are the same as those related to the decision table 240b described in FIG. 7.

The static dictionary information 240c is information in which words are associated with static codes.

The dynamic dictionary information 240d is information that is used to allocate a dynamic code to a word (or a character string) that has not been defined in the static dictionary information 240c.

The control unit 250 includes an accepting unit 250a, a generating unit 250b, a specifying unit 250c, and a responding unit 250d. The control unit 250 can be implemented by a CPU, an MPU, or the like. Furthermore, the control unit 250 can also be implemented by hard-wired logic, such as an ASIC or an FPGA.

The accepting unit 250a accepts the search sentence data F11 from the communication unit 210 or the input unit 220. The accepting unit 250a registers the accepted search sentence data F11 in the search sentence DB 240a. When the accepting unit 250a accepts the question sentence data F1 from the communication unit 210, the accepting unit 250a may also associate the information on the device that becomes the transmission source of the search sentence data F11 with the search sentence data F11 and register the associated information in the search sentence DB 240a.

The generating unit 250b is a processing unit that acquires the search sentence data F11 from the search sentence DB 240a and that generates the text vector information F12 based on the search sentence data F11. The generating unit 250b outputs the generated text vector information F12 to the specifying unit 250c. The process in which the generating unit 250b generates the text vector information F12 from the search sentence data F11 is the same as the process in which the generating unit 150b generates the text vector information F2 from the question sentence data F1.

The specifying unit 250c is a processing unit that specifies a thesis associated with the search sentence data F11 based on the text vector information F12 and the decision table 240b. First, the specifying unit 250c specifies the type and the positional relationship of the dimensional components included in the text vector information F12.

The specifying unit 250c previously holds the information on each of the types of vector components of dimensions. In the second embodiment, as an example, it is assumed that the types of the dimensional components are “Vec000 to Vec255”. The specifying unit 250c compares, from among the vector components included in the sentence vector xVec1 included in the text vector information F12, a dimensional value of the dimensional component with the threshold and decides whether the dimensional component in which the dimensional value of the dimensional component is equal to or greater than the threshold is included. The specifying unit 250c also repeatedly performs the same process on the sentence vectors xVec2 to xVecn included in the text vector information F12.

The specifying unit 250c specifies the sentence vector that has a dimensional component in which the dimensional value is equal to or greater than the threshold and specifies the type of the dimensional component in which the dimensional value included in the subject sentence vector is equal to or greater than the threshold. Furthermore, the specifying unit 250c specifies the positional relationship of the sentence vectors each having the dimensional component in which the dimensional value is equal to or greater than the threshold. Here, specifying the positional relationship of the sentence vectors each having the dimensional component in which the dimensional value is equal to or greater than the threshold corresponds to specifying the type of the dimensional components included in the text vector information F12 and the positional relationship of each of the dimensional components.

For example, in the example illustrated in FIG. 7, from among the sentence vectors xVec1 to xVecn, the vectors each having the dimensional component in which the dimensional value is equal to or greater than a predetermined threshold are the sentence vector xVec2 and the sentence xVec3. Furthermore, regarding the sentence vector xVec2, the dimensional value of the dimensional component “Vec122” is equal to or greater than the predetermined dimensional value and, regarding the sentence vector xVec3, the dimensional value of the dimensional component “Vec033” is equal to or greater than the predetermined dimensional value. The types and the positional relationships of the dimensional components in each of which the dimensional value is equal to or greater than the threshold are in the order of “Vec122” and “Vec033”.

The specifying unit 250c compares, after having specified the type and the positional relationship of the dimensional components, the type and the positional relationship of the specified dimensional components with the inverted index T in the decision table 240b and then specifies the thesis associated with the search sentence data F11.

The specifying unit 250c searches the inverted index T for the inverted index in which the flag “1” is to be set to the type of the dimensional components in each of which the dimensional value is equal to or greater than the threshold. For example, it is assumed that the dimensional components that are specified from the text vector information F12 and in each of which the dimensional value is equal to or greater than the threshold are “Vec122” and “Vec033”, the specifying unit 250c specifies the inverted index T11 and the inverted index T12 illustrated in FIG. 7.

If the specifying unit 250c specifies a plurality of inverted indices, the specifying unit 250c narrows down the inverted indices by using, as a key, the type and the positional relationship of the dimensional components that have been specified from the text vector information F12. For example, because the dimensional component “Vec033” appearing after the dimensional component “Vec122” is the inverted index T12, the specifying unit 250c ultimately specifies the inverted index T12. The specifying unit 250c acquires the thesis B2 associated with the specified inverted index 12 from the decision table 240b and outputs the thesis B2 to the responding unit 150d.

Furthermore, the specifying unit 250c may also search the inverted index T for the inverted index in which the flag “1” is to be set to the type of the dimensional components in each of which the dimensional value is equal to or greater than the threshold and specify, in a case where only a single inverted index is present, the single inverted index regardless of the positional relationship. The specifying unit 250c acquires the thesis associated with the specified inverted index from the decision table 240b and outputs the thesis to the responding unit 250d.

The responding unit 250d is a processing unit that generates the search result data F13 based on the thesis acquired from the specifying unit 250c and that sends the generated search result data F13 to the device that becomes the transmission source of the search sentence data F11. If the responding unit 250d has accepted the search sentence data F11 from the input unit 220, the responding unit 250d outputs the search result data F13 to the display unit 230 and allows the display unit 230 to display the search result data F13.

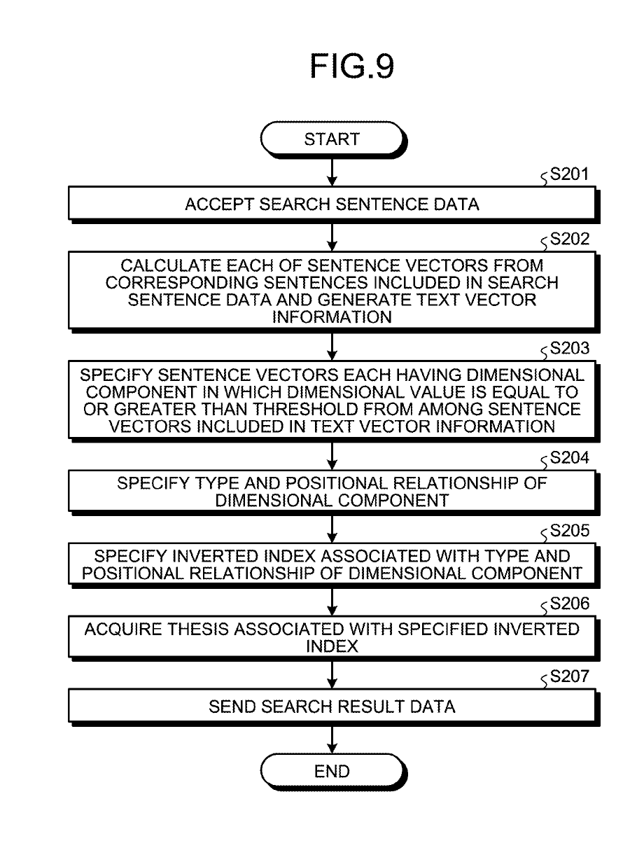

In the following, an example of the flow of a process performed by the information processing apparatus 200 according to the second embodiment will be described. FIG. 9 is a flowchart illustrating the flow of the process performed by the information processing apparatus according to the second embodiment. As illustrated in FIG. 9, the accepting unit 250a in the information processing apparatus 200 acquires the search sentence data F11 (Step S201).

The generating unit 250b in the information processing apparatus 200 calculates each of the sentence vectors from the sentences included in the search sentence data F11 and generates the text vector information F12 (Step S202). The specifying unit 250c in the information processing apparatus 200 specifies, from among the sentence vectors included in the text vector information F12, the sentence vectors each having the dimensional component in which the dimensional value is equal to or greater than the threshold (Step S203).

The specifying unit 250c specifies the types and the positional relationship (order) between the dimensional components based on the text vector information F12 (Step S204). The specifying unit 250c specifies the inverted index associated with the types and the positional relationship between the dimensional components (Step S205). The specifying unit 250c acquires the thesis associated with the specified inverted index (Step S206). The responding unit 250d sends the search result data F13 to the device that is the transmission source of the search sentence data F11 (Step S207).

In the following, the effects of the information processing apparatus 200 according to the second embodiment will be described. The information processing apparatus 200 previously generates the decision table 240b in which theses are associated with the inverted index T in which the position information on the dimensional components is defined. When the information processing apparatus 200 acquires the search sentence data F11, the information processing apparatus 200 generates the text vector information F12 based on the search sentence data F11, compares the inverted index T with the type and the positional relationship of the dimensional components included in the generated text vector information F12, and specifies the inverted index associated with the type and the positional relationship of the dimensional components. The information processing apparatus 200 uses the thesis associated with the specified inverted index and generates the search result data F13. In this way, because the thesis (text associated with the thesis) is specified by comparing the inverted index T with the type and the positional relationship of the dimensional components included in the text vector information F12, it is possible to specify sentences and their positions with high accuracy in accordance with the granularity, such as chapters, sections, or paragraphs that constitute a text.

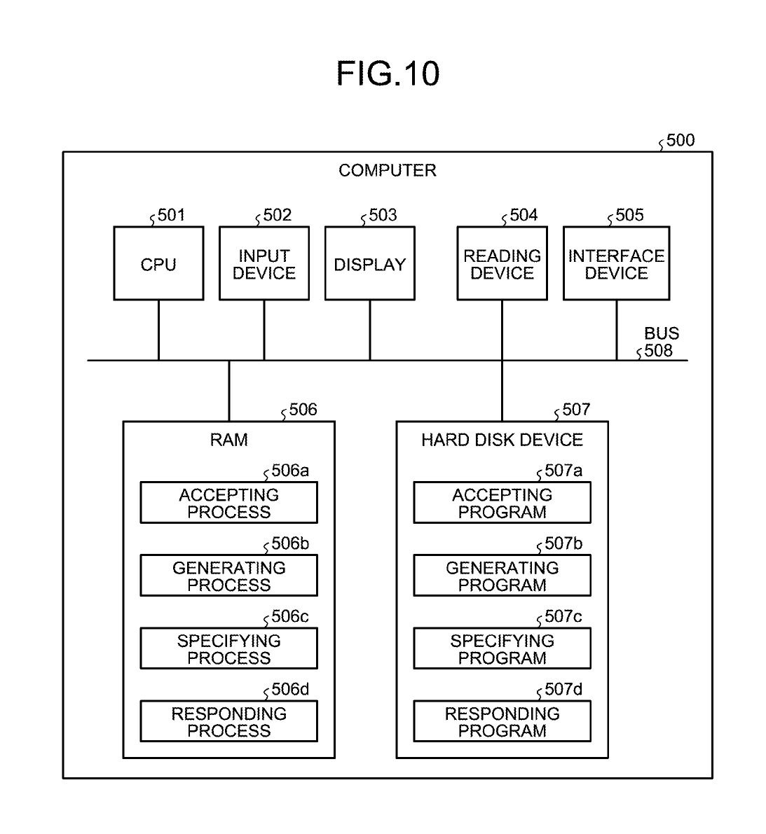

In the following, a description will be given of an example of a hardware configuration of a computer that implements the same function as that of the information processing apparatuses 100 and 200 described above in the embodiments. FIG. 10 is a diagram illustrating an example of the hardware configuration of the computer that implements the same function as that of the information processing apparatus.

As illustrated in FIG. 10, a computer 500 includes a CPU 501 that executes various kinds of arithmetic processing, an input device 502 that accepts an input of data from a user, and a display 503. Furthermore, the computer 500 includes a reading device 504 that reads programs or the like from a storage medium and an interface device 505 that sends and receives data to and from recording equipment via a wired or wireless network. Furthermore, the computer 500 includes a RAM 506 that temporarily stores therein various kinds of information and a hard disk device 507. Each of the devices 501 to 507 is connected to a bus 508.

The hard disk device 507 has an accepting program 507a, a generating program 507b, a specifying program 507c, and a responding program 407d. The CPU 501 reads each of the programs 507a to 507d and loads the programs in the RAM 506.

The accepting program 507a functions as an accepting process 506a. The generating program 507b functions as a generating process 506b. The specifying program 507c functions as a specifying process 506c. The responding program 507d functions as a responding process 506d.

The process of the accepting process 506a corresponds to the process performed by the accepting units 150a and 250a. The process of the generating process 506b corresponds to the process performed by the generating units 150b and 250b. The process of the specifying process 506c corresponds to the process performed by the specifying units 150c and 250c. The process of the responding process 506d corresponds to the process performed by the responding units 150d and 250d.

Furthermore, each of the programs 507a to 507d does not need to be stored in the hard disk device 507 in advance from the beginning. For example, each of the programs is stored in a “portable physical medium”, such as a flexible disk (FD), a CD-ROM, a DVD disk, a magneto-optic disk, an IC CARD, that is to be inserted into the computer 500. Then, the computer 500 may also read each of the programs 507a to 507d from the portable physical medium and execute the programs.

It is possible to specify a text with high accuracy.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer readable recording medium having stored therein a specifying program that causes a computer to execute a process comprising:
generating, when accepting a text, based on the accepted text, vectors including a plurality of dimensional values associated with a plurality of corresponding dimensions;
first specifying, from among the plurality of dimensions, a dimension in which the associated dimensional value meets the criterion;
comparing the specified dimension with a storage unit that stores therein information that associates vectors each having a dimension in which the associated dimensional value meets the criterion with the positions of the corresponding vectors, regarding each of a plurality of texts, from among the dimensions included in the vectors of the texts; and
second specifying a text associated with the specified dimension from among the plurality of texts.

2. The non-transitory computer readable recording medium according to claim 1, wherein
the information stored in the storage unit is information in which the texts are associated with index information in which types of dimensions each having a dimensional value that meets a criterion value are associated with position information,
the generating generates, when accepting the text, each of the vectors of corresponding sentences included in the text,
the first specifying specifies, from among the dimensions included in each of the vectors of the corresponding sentences, a type of the dimension in which the dimensional value meets the criterion, and
the second specifying specifies, based on the type and the positional relationship of the specified dimension and based on the index information, the text associated with the type and the positional relationship of the specified dimension.

3. The non-transitory computer readable recording medium according to claim 2, wherein
the generating generates the vectors from the text related to a search condition of a thesis,
the information stored in the storage unit is information in which the index information generated based on the thesis is associated with the thesis, and
the second specifying specifies the thesis associated with the type and the positional relationship of the specified dimension, based on the type and the positional relationship of the specified dimension and based on the index information.

4. The specifying program according to claim 1 wherein the generating generates, when accepting the text, the vectors based on the granularity that is associated with one of chapters of the sentences, sections of the sentences, paragraphs of the sentences, and the sentences that are included in the accepted text.

5. A specifying method comprising:
generating, when accepting a text, based on the accepted text, vectors including a plurality of dimensional values associated with a plurality of corresponding dimensions, using a processor;
first specifying, from among the plurality of dimensions, a dimension in which the associated dimensional value meets the criterion, using the processor;
comparing the specified dimension with a storage unit that stores therein information that associates vectors each having a dimension in which the associated dimensional value meets the criterion with the positions of the corresponding vectors, regarding each of a plurality of texts, from among the dimensions included in the vectors of the texts, using the processor; and
second specifying a text associated with the specified dimension from among the plurality of texts, using the processor.

6. The specifying method according to claim 5, wherein
the information stored in the storage unit is information in which the texts are associated with index information in which types of dimensions each having a dimensional value that meets a criterion value are associated with position information,
the generating generates, when accepting the text, each of the vectors of corresponding sentences included in the text,
the first specifying specifies, from among the dimensions included in each of the vectors of the corresponding sentences, a type of the dimension in which the dimensional value meets the criterion, and
the second specifying specifies, based on the type and the positional relationship of the specified dimension and based on the index information, the text associated with the type and the positional relationship of the specified dimension.

7. The specifying method according to claim 6, wherein
the generating generates the vectors from the text related to a search condition of a thesis,
the information stored in the storage unit is information in which the index information generated based on the thesis is associated with the thesis, and
the second specifying specifies, the thesis associated with the type and the positional relationship of the specified dimension based on the type and the positional relationship of the specified dimension and based on the index information.

8. The specifying method according to claim 5 wherein the generating generates, when accepting the text, the vectors based on the granularity that is associated with one of chapters of the sentences, sections of the sentences, paragraphs of the sentences, and the sentences that are included in the accepted text.

9. An information processing apparatus comprising:
a memory; and
a processor coupled to the memory, wherein the processor executes a process comprising:
generating, when accepting a text, based on the accepted text, vectors including a plurality of dimensional values associated with a plurality of corresponding dimensions;
first specifying, from among the plurality of dimensions, a dimension in which the associated dimensional value meets the criterion;
comparing the specified dimension with the memory that stores therein information that associates vectors each having a dimension in which the associated dimensional value meets the criterion with the positions of the corresponding vectors, regarding each of a plurality of texts, from among the dimensions included in the vectors of the texts; and
second specifying a text associated with the specified dimension from among the plurality of texts.

10. The information processing apparatus according to claim 9, wherein
the information stored in the memory is information in which the texts are associated with index information in which types of dimensions each having a dimensional value that meets a criterion value are associated with position information,
the generating generates, when accepting the text, each of the vectors of corresponding sentences included in the text, and
the first specifying specifies, from among the dimensions included in each of the vectors of the corresponding sentences, a type of the dimension in which the dimensional value meets the criterion, and
the second specifying specifies, based on the type and the positional relationship of the specified dimension and based on the index information, the text associated with the type and the positional relationship of the specified dimension.

11. The information processing apparatus according to claim 10, wherein
the generating generates the vectors from the text related to a search condition of a thesis,
the information stored in the memory is information in which the index information generated based on the thesis is associated with the thesis, and
the second specifying specifies the thesis associated with the type and the positional relationship of the specified dimension, based on the type and the positional relationship of the specified dimension and based on the index information.

12. The information processing apparatus according to claim 9, wherein the generating generates, when accepting the text, the vectors based on the granularity that is associated with one of chapters of the sentences, sections of the sentences, paragraphs of the sentences, and the sentences that are included in the accepted text.
